(19) United States
(12) Patent Application Publication
(10) Pub. No.: US 2012/0200404 A1
(43) Pub. Date: Aug. 9, 2012

(54) METHODS, SYSTEMS, AND COMPUTER PROGRAM PRODUCTS FOR ALTERING ATTENTION OF AN AUTOMOTIVE VEHICLE OPERATOR

(76) Inventor: Robert Paul Morris, Raleigh, NC (US)

(21) Appl. No.: 13/023,932

(22) Filed: Feb. 9, 2011

(51) Int. Cl. B60Q 1/00

(52) U.S. Cl. 340/438

(57) ABSTRACT

Methods and systems are described for altering attention of an automotive vehicle operator. Interaction information is received that is based on a first interaction that includes a first operator of a first automotive vehicle. A second automotive vehicle is detected, wherein the second automotive vehicle is operated by a second operator. Based on the interaction information, attention information for identifying an attention output is determined. The attention information is sent, for presenting the attention output, by an output device, to alter a second interaction that includes the second operator.

### RELATED APPLICATIONS

This application is related to the following commonly owned U.S. Patent Applications, the entire disclosures being incorporated by reference herein: application Ser. No. __/__,__ (Docket No 0075) filed on Feb. 9, 2011, entitled “Methods, Systems, and Program Products for Directing Attention of an Occupant of an Automotive Vehicle to a Viewport”;

Application Ser. No. __/__,__ , (Docket No 0133) filed on Feb. 9, 2011, entitled “Methods, Systems, and Program Products for Directing Attention to a Sequence of Viewports of an Automotive Vehicle”; and

Application Ser. No. __/__,__ , (Docket No 0171) filed on Feb. 9, 2011, entitled “Methods, Systems, and Program Products for Managing Attention of an Operator of an Automotive Vehicle”.

### BACKGROUND

Driving while distracted is a significant cause of highway accidents. Recent attention to the dangers of driving while talking on a phone and/or driving while “texting” have brought the public's attention to this problem. While the awareness is newly heightened the problem is quite old. Driving while eating, adjusting a car's audio system, and even talking to other passengers can and do take driver's attention away from driving, creating risks.

Regardless of the attentiveness of the operator of an automotive vehicle, lack of attentiveness of other drivers of other vehicles may pose a risk is to the operator and any other occupants of the automotive vehicle.

A need exists to assist drivers in focusing their attention where it is needed to increase highway safety. Accordingly, there exists a need for methods, systems, and computer program products for altering attention of an automotive vehicle operator.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for altering attention of an automotive vehicle operator. In one aspect, the method includes receiving interaction information based on a first interaction that includes a first operator of a first automotive vehicle. The method further includes detecting a second automotive vehicle, wherein the second automotive vehicle is operated by a second operator. The method still further includes determining, based on the interaction information, attention information for identifying an attention output. The method also includes sending the attention information for presenting the attention output, by an output device, to alter a second interaction that includes the second operator.

Further, a system for altering attention of an automotive vehicle operator is described. The system includes an interaction monitor component, a vehicle detector component, an attention control component, and an attention director component adapted for operation in an execution environment. The system includes the interaction monitor component configured for receiving interaction information based on a first interaction that includes a first operator of a first automotive vehicle. The system further includes the vehicle detector component configured for detecting a second automotive vehicle, wherein the second automotive vehicle is operated by a second operator. The system still further includes the attention control component configured for determining, based on the interaction information, attention information for identifying an attention output. The system still further includes the attention director component configured for sending the attention information for presenting the attention output, by an output device, to alter a second interaction that includes the second operator.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for altering attention of an automotive vehicle operator according to an aspect of the subject matter described herein;

FIG. 3 is a block diagram illustrating an arrangement of components for altering attention of an automotive vehicle operator according to another aspect of the subject matter described herein;

FIG. 4a is a block diagram illustrating an arrangement of components for altering attention of an automotive vehicle operator according to another aspect of the subject matter described herein;

FIG. 4b is a block diagram illustrating an arrangement of components for altering attention of an automotive vehicle operator according to another aspect of the subject matter described herein;

FIG. 5 is a network diagram illustrating an exemplary system for altering attention of an automotive vehicle operator according to another aspect of the subject matter described herein; and

FIG. 6 is a diagram illustrating a user interface presented to an occupant of an automotive vehicle in another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

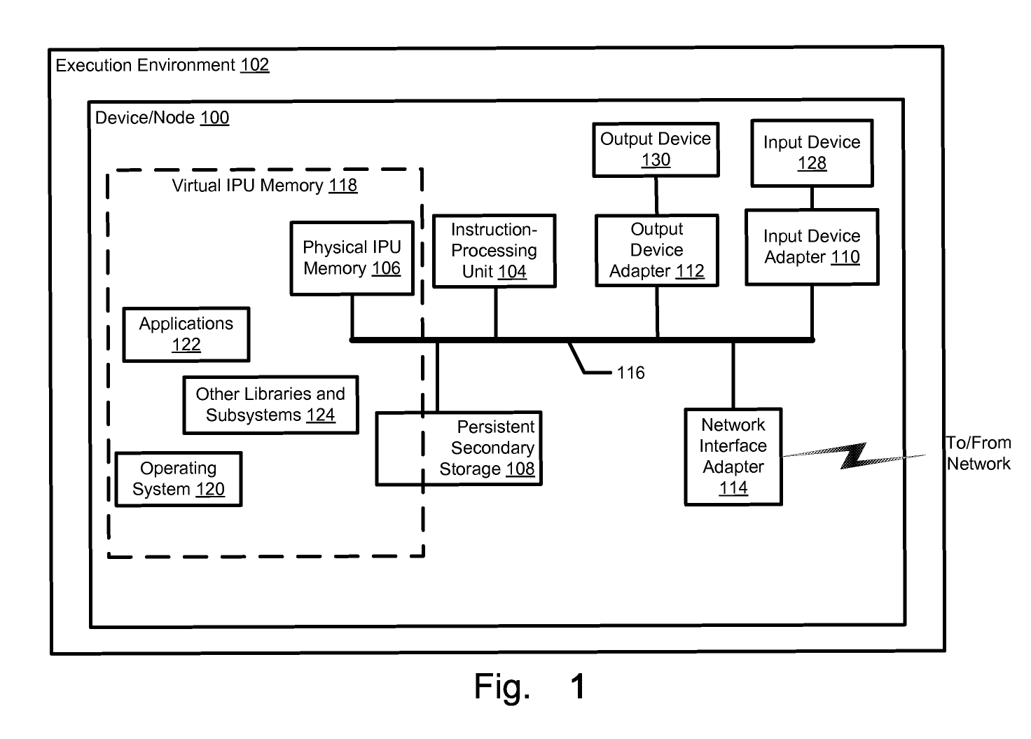

An exemplary device included in an execution environment that may be configured according to the subject matter is illustrated in FIG. 1. An execution environment includes an arrangement of hardware and, in some aspects, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in and/or otherwise providing suitable execution environments for configuring according to the subject matter include an automobile, a truck, a van, and/or sports utility vehicle. Alternatively or additionally a suitable execution environment may include and/or may be included in a personal computer, a notebook computer, a tablet computer, a server, a portable electronic device, a handheld electronic device, a mobile device, a multiprocessor device, a distributed system, a consumer electronic device, a router, a communication server, and/or any other suitable device. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be identified by an operand of a machine code instruction and/or may be identified by a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable medium. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of user interface elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

An order of visual outputs in a depth dimension is herein referred to as a “Z-order”. The term “Z-value” as used herein refers to a location in a Z-order. A Z-order specifies the front-to-back ordering of visual outputs in a presentation space. A visual output with a higher Z-value than another visual output may be defined to be on top of or closer to the front than the other visual output, in one aspect.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as JPEG, video formats such as MP4, markup language data such as hypertext markup language (HTML) and other XML-based markup, a bit map, and/or instructions such as those defined by various script languages, byte code, and/or machine code. For example, a web page received by a browser from a remote application provider may include HTML, ECMAScript, and/or byte code for presenting one or more user interface elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate languages for processing by an interpreter, compiler, linker, loader, and/or other analogous tool.

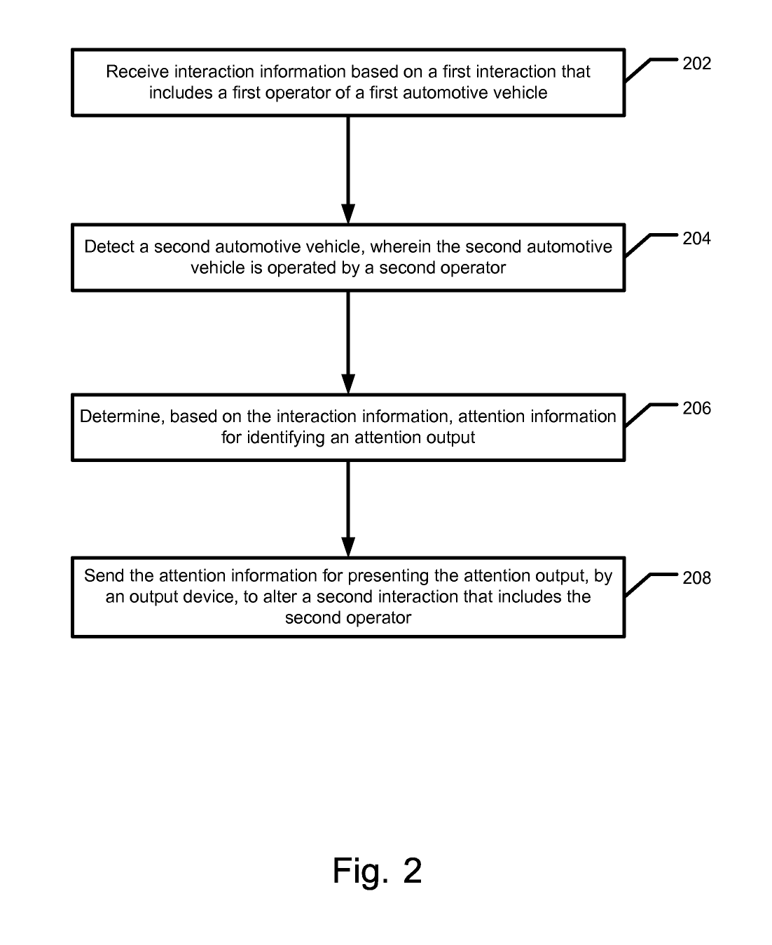

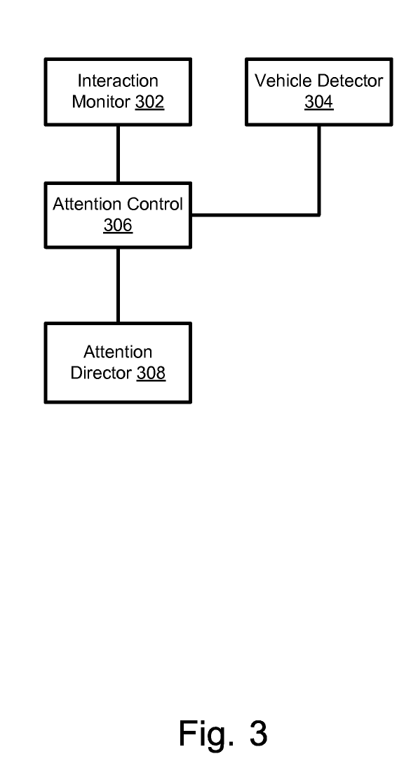

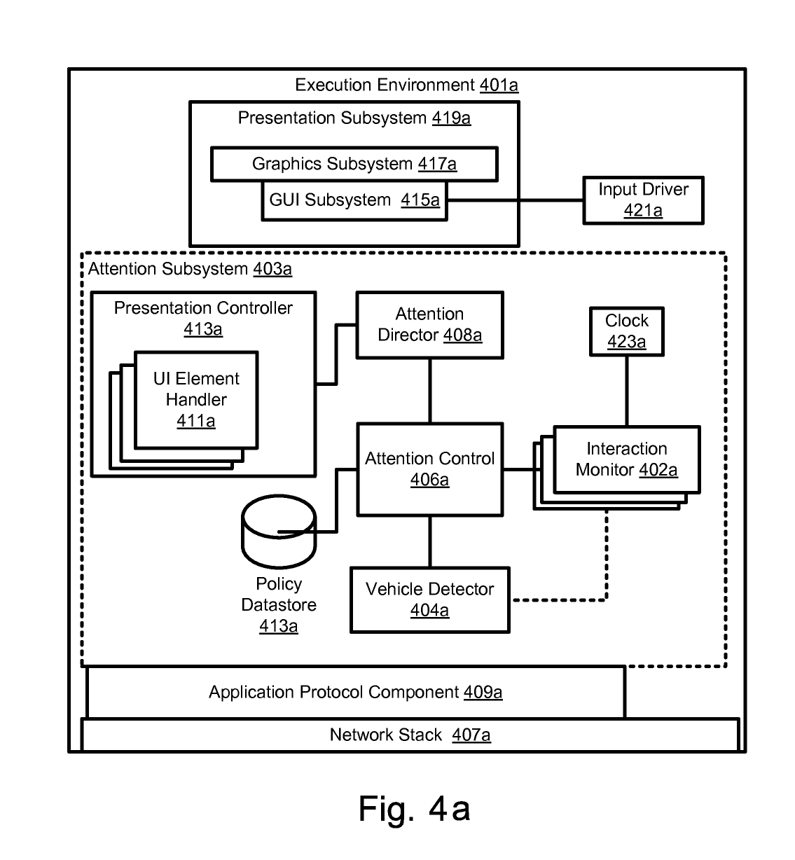

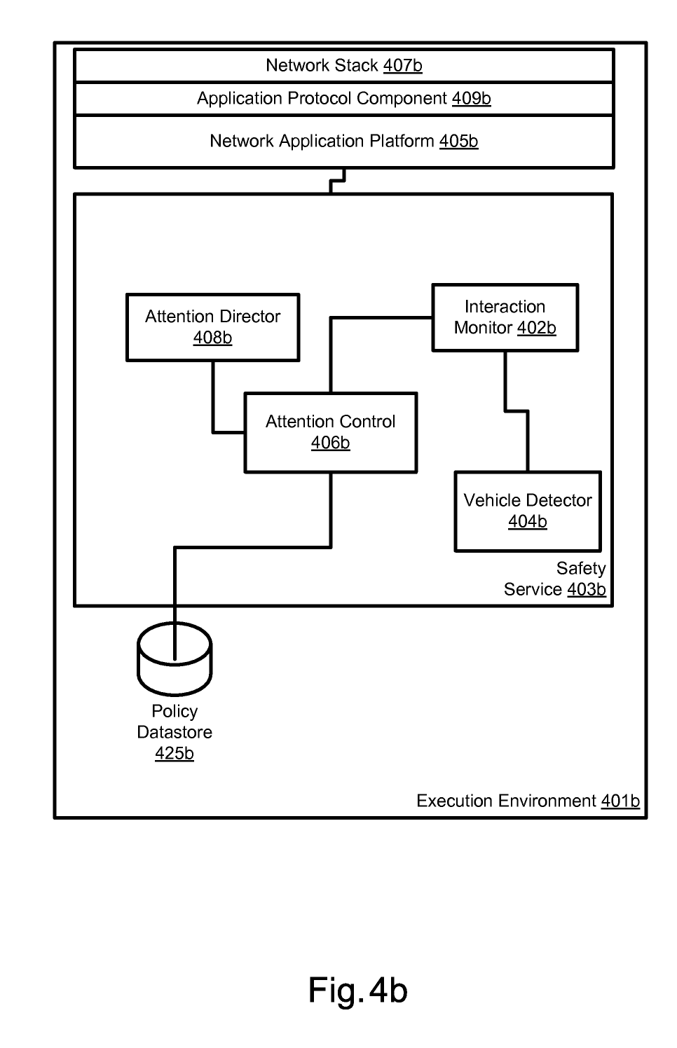

The block diagram in FIG. 3 illustrates an exemplary system for altering attention of an automotive vehicle operator according to the method illustrated in FIG. 2. FIG. 3 illustrates a system, adapted for operation in an execution environment, such as execution environment 102 in FIG. 1, for performing the method illustrated in FIG. 2. The system illustrated includes an interaction monitor component 302, a vehicle detector component 304, an attention control component 306, and an attention director component 308. The execution environment includes an instruction-processing unit, such as IPU 104, for processing an instruction in at least one of the interaction monitor component 302, the vehicle detector component 304, the attention control component 306, and the attention director component 308. Some or all of the exemplary components illustrated in FIG. 3 may be adapted for performing the method illustrated in FIG. 2 in a number of execution environments. FIGS. 4a-b are each block diagrams illustrating the components of FIG. 3 and/or analogs of the components of FIG. 3 respectively adapted for operation in execution environment 401a and execution environment 401b that include or that otherwise are provided by one or more nodes. Components, illustrated in FIG. 4a and FIG. 4b, are identified by numbers with an alphabetic character postfix. Execution environments; such as execution environment 401a, execution environment 401b, and their adaptations and analogs; are referred to herein generically as execution environment 401 or execution environments 401 when describing more than one. Other components identified with an alphabetic postfix may be referred to generically or as a group in a similar manner.

FIG. 1 illustrates key components of an exemplary device that may at least partially provide and/or otherwise be included in an execution environment. The components illustrated in FIG. 4a and FIG. 4b may be included in or otherwise combined with the components of FIG. 1 to create a variety of arrangements of components according to the subject matter described herein.

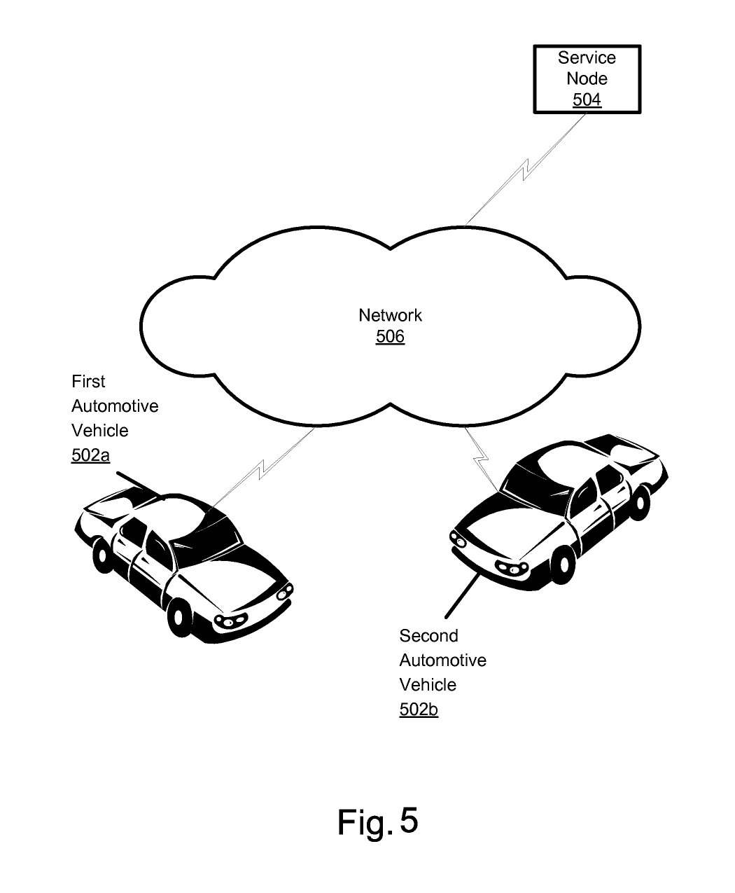

FIGS. 4a illustrates execution environment 401a including an adaptation of the arrangement of components in FIG. 3. In an aspect, execution environment 401a may be included in an automotive vehicle. In FIG. 5 one or both of first automotive vehicle 502a and second automotive vehicle 502b may include and/or otherwise provide an instance of execution environment 401a or an analog. FIG. 4b illustrates execution environment 401b configured to host a network accessible application illustrated by safety service 403b. Safety service 403b includes another adaptation or analog of the arrangement of components in FIG. 3. In an aspect, execution environment 401b may include and/or otherwise be provided by service node 504 illustrated in FIG. 5.

Adaptations and/or analogs of the components illustrated in FIG. 3 may be installed persistently in an execution environment while other adaptations and analogs may be retrieved and/or otherwise received as needed via a network. In an aspect, some or all of the arrangement of components operating in an execution environment of an automotive vehicle 502 may be received via network 506. For example, service node 504 may provide some or all of the components.

An arrangement of components for performing the method illustrated in FIG. 2 may operate in a particular execution environment, in one aspect, and may be distributed across more than one execution environment, in another aspect. Various adaptations of the arrangement in FIG. 3 may operate at least partially in an execution environment in first automotive vehicle 502a, at least partially in the execution environment in second automotive vehicle 502b, and/or at least partially in the execution environment in service node 504.

As stated the various adaptations of the arrangement in FIG. 3 described herein are not exhaustive. For example, those skilled in the art will see based on the description herein that arrangements of components for performing the method illustrated in FIG. 2 may be adapted to operate in an automotive vehicle, in a node other than an automotive vehicle, and may be distributed across more than one node in a network and/or more than one execution environment.

As described above, FIG. 5 illustrates automotive vehicles 502. An automotive vehicle may include a gas powered, oil powered, bio-fuel powered, solar powered, hydrogen powered, and/or electricity powered car, truck, van, bus, or the like. In an aspect, an automotive vehicle 502 may communicate with one or more application providers, also referred to as service providers, via a network, illustrated by network 506 in FIG. 5. Service node 504 illustrates one such application provider. An automotive vehicle 502 may communicate with network application platform 405b in FIG. 4b operating in execution environment 401b included in and/or otherwise provided by service node 504 in FIG. 5. An automotive vehicle 502 and service node 504 may each include a network interface component operatively coupling each respective node to network 506.

In still another aspect, automotive vehicles 502 may be communicatively coupled. FIG. 5 illustrates that, in an aspect, second automotive vehicle 502b and first automotive vehicle 502a may communicate via network 506. The communicative couplings between and among first automotive vehicle 502a, second automotive vehicle 502b, and service node 504 are exemplary and, thus, not exhaustive.

FIGS. 4a-b illustrates network stacks 407 configured for sending and receiving data over a network such as the Internet. Network application platform 405b in FIG. 4b may provide one or more services to safety service 403b. For example, network application platform 405b may include and/or otherwise provide web server functionally on behalf of safety service 403b. FIG. 4b also illustrates network application platform 405b configured for interoperating with network stack 407b providing network services for safety service 403b. Network stack 407a FIG. 4a serves a role analogous to network stack 407b.

Network stacks 407, operating in nodes illustrated in FIG. 5, may support the same protocol suite, such as TCP/IP, or may enable their hosting nodes to communicate via a network gateway (not shown) or other protocol translation device (not shown) and/or service (not shown). For example, first automotive vehicle 502a and service node 504 in FIG. 5 may interoperate via their respective network stacks: network stack 407a in FIG. 4a and network stack 407b in FIG. 4b.

FIG. 4a illustrates attention subsystem 403a and FIG. 4b illustrates safety service 403b, respectively, which may communicate via one or more application protocols. FIGS. 4a-b illustrate application protocol components 409 exemplifying components configured to communicate according to one or more application protocols. Exemplary application protocols include a hypertext transfer protocol (HTTP), a remote procedure call (RPC) protocol, an instant messaging protocol, and a presence protocol. Application protocol components 409 in FIGS. 4a-b may support compatible application protocols. Matching protocols enable, for example, an attention subsystem 403a supported by automotive vehicle 502a to communicate with safety service 403b of service node 506 via network 508 in FIG. 5. Matching protocols are not required if communication is via a protocol gateway or other protocol translator.

In FIG. 4a, attention subsystem 403a may receive some or all of the arrangement of components in FIG. 4a in one more messages received via network 506 from another node. In an aspect, the one or more messages may be sent by safety service 403b via network application platform 405b, network stack 407b, a network interface component, and/or application protocol component 409b in execution environment 401b. Attention subsystem 403a may interoperate with one or more of the application protocols provided by application protocol component 409a and/or network stack 407a to receive the message or messages including some or all of the components and/or their analogs adapted for operation in execution environment 401a.

Execution environment 401a may include one or more UI element handler components 411a. In one aspect, presentation controller 413a, as illustrated in FIG. 4a, may include one or more UI element handler components 411a. Alternatively or additionally, a presentation controller component may be configured to interoperate with one or more UI element handler components external to the presentation controller component. A presentation controller component may manage the visual, audio, and/or other types of output of an application or executable. A presentation controller component and/or a UI element handler component may be configured to receive and route detected user and other inputs to components and extensions of its including application or executable.

UI element handler components and a presentation controller component are not shown in FIG. 4b, but those skilled in the art will understand upon reading the description herein that adaptations and/or analogs of these components configured to perform analogous operations may be adapted for operating in execution environment 401b as well.

A UI element handler component in various aspects may be adapted to operate at least partially in a content handler component (not shown) such as a text/html content handler component and/or a script content handler component. One or more content handlers may operate in an application such as a web browser. Additionally or alternatively, a UI element handler component in an execution environment may operate in and/or as an extension of its controlling application or executable. For example, a plug-in may provide a UI element handler component received as a script and/or byte code that may operate as an extension operating in a thread and/or process of an application and/or operating external to and interoperating with the application.

GUI subsystem 415a illustrated FIG. 4a may instruct a corresponding graphics subsystem 417a to draw a UI interface element in a region of a display presentation space, based on presentation information received from a corresponding UI element handler component 411a. Graphics subsystem 417a and a GUI subsystem 415a may be included in a presentation subsystem, illustrated in FIG. 4a by presentation subsystem 419a. Presentation subsystem 419a may include one or more output devices and/or may otherwise be operatively coupled to one or more output devices.

In some aspects, input may be received and/or otherwise detected via one or more input drivers illustrated by input driver 421a in FIGS. 4a. An input may correspond to a UI element presented via an output device. For example, a user may manipulate a pointing device, such as a touch screen, so that a pointer presented in a display presentation space is presented over a particular user interface element, representing a selectable operation. A user may provide an input detected by input driver 421a. The detected input may be received by GUI subsystem 415a via the input driver 421a as an operation or command indicator based on the association of the shared location of the pointer and the operation user interface element. FIG. 4a illustrates input driver 421a operatively coupled to GUI subsystem 415a. Input driver 421a may detect an input and may provide information based on the input to GUI subsystem 415a, directly and/or indirectly. One or more components in attention subsystem 403a may receive input information in response to an input detected by an input driver 421a via GUI subsystem 415a. In another aspect, input driver 421a may provide input information to one or more components of attention subsystem 403a without GUI subsystem 415a operating as an intermediary.

An “interaction”, as the term is used herein, refers to any activity including a user and an object where the object is a source of sensory input detected by the user. In an interaction the user directs attention to the object. An interaction may also include the object as a target of input from the user. The input may be provided intentionally or unintentionally by the user. For example, a rock being held in the hand of a user is a target of input, both tactile and energy input, from the user. A portable electronic device is a type of object. In another example, a user looking at a portable electronic device is receiving sensory input from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction and presented by an output device included in the interaction.

As used herein “interaction information” refers to any information that identifies an interaction and/or otherwise provides data about an interaction between the user and an object, such as a personal electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

The term “occupant” as used herein refers to a passenger of an automotive vehicle. An operator of an automotive vehicle is an occupant of the automotive vehicle. As the terms are used herein, an “operator” of an automotive vehicle and a “driver” of an automotive vehicle are equivalent.

Interaction information for one viewport may include and/or otherwise identify interaction information for another viewport and/or other object. For example, a motion detector may detect an operator's head turn in the direction of a windshield of first automotive vehicle 502a in FIG. 5. Interaction information identifying the operator's head is facing the windshield may be received and/or used as interaction information for the windshield indicating the operator's is receiving visual input from a viewport provided by some or all of the windshield. The interaction information may serve to indicate a lack of operator interaction with one or more other viewports such as a rear window of the automotive vehicle. Thus the interaction information may serve as interaction information for one or more viewports.

The term “viewport” as used herein refers to any opening and/or surface of an automobile that provides a view of a space outside the automotive vehicle. A window, a screen of a display device, a projection from a projection device, and a mirror are all viewports and/or otherwise included in a viewport. A view provided by a viewport may include an object external to the automotive vehicle visible to the operator and/other occupant. The external object may be an external portion of the automotive vehicle or may be an object that is not part of the automotive vehicle.

With reference to FIG. 2, block 202 illustrates that the method includes receiving interaction information based on a first interaction that includes a first operator of a first automotive vehicle. Accordingly, a system for altering attention of an automotive vehicle operator includes means for receiving interaction information based on a first interaction that includes a first operator of a first automotive vehicle. For example, as illustrated in FIG. 3, interaction monitor component 302 is configured for receiving interaction information based on a first interaction that includes a first operator of a first automotive vehicle. FIGS. 4a-b illustrate interaction monitor components 402 as adaptations and/or analogs of interaction monitor component 302 in FIG. 3. One or more interaction monitor components 402 operate in an execution environment 401.

In FIG. 4a, interaction monitor component 402a is illustrated as a component of attention subsystem 403a. In FIG. 4b, interaction monitor component 402b is illustrated as a component of safety service 403b. In various aspects, adaptations and analogs of interaction monitor component 302 in FIG. 3, such as interaction monitor components 402 in FIGS. 4a-b, may receive interaction information including and/or otherwise based on an interaction between an operator of an automotive vehicle and an object. For example, interaction information may identify a direction of the object relative to the operator. The object included in the interaction may be the automotive vehicle, a part of the automotive vehicle, an object transported by the automotive vehicle, or an object external to the automotive vehicle.

An interaction monitor component 402 may be adapted to receive interaction information in any suitable manner, in various aspects. For example receiving interaction information may include receiving a message via network, receiving data via a communications interface, detecting a user input, sending a message via a network, receiving data in response to data sent via a communications interface, receiving data via user interaction with a presented user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt. Exemplary invocation mechanisms include a function call, a method call, and a subroutine call. An invocation mechanism may pass data to and/or from a vehicle detector component via a stack frame and/or via a register of an IPU. Exemplary IPC mechanisms include a pipe, a semaphore, a signal, a shared data area, a hardware interrupt, and a software interrupt.

Interaction information may include and/or identify a measure of visual interaction, auditory interaction, tactile interaction, and/or physical responsiveness. Interaction information may identify an object included in an interaction with an operator of an automotive vehicle. An operator may be included in more than one interaction at any particular time and/or during a specified period of time. Interaction information may identify and/or otherwise include information about an interaction that is not and/or has not occurred. For example, a measure of interaction between an operator and a rear-window of an automotive vehicle may indicate that no interaction is occurring at a particular time and/or in a particular time period.

A metric for specifying a measure of interaction may be defined based on a number of predefined states of interaction which are discrete, in one aspect. A metric may be defined based on a mathematical calculation for determining a measure of interaction. The calculation may include evaluating a continuous function, for example. Interaction information, may identify an object included in and/or not included in an interaction with the operator, may identify a space and/or location that includes an object included in an interaction, and/or may identify a space including objects that are not included in an interaction with an operator.

A motion detector in first automotive vehicle 502a in FIG. 5 may be configured to detect an operator's head turn in the direction of the windshield of first automotive vehicle 502a. Interaction information identifying the operator's head is facing the windshield may be received interaction monitor component 402a operating in first automotive vehicle 502a. In another aspect, interaction monitor component 402a may determine that little or no interaction is occurring that includes the operator and an object other than the windshield based on the received interaction information for the windshield.

Interaction information may be received in response to an input sensed and/or otherwise detected by an input device and/or in response to a lack of an input in a specified context or condition. For example, an operator press of a fuel pedal may be detected. An interaction monitor component 402 in FIGS. 4a-b may receive interaction information in response to the detecting of the press of the fuel pedal by the operator of first automotive vehicle 502a. The interaction information may identify an interaction between the operator and the fuel pedal. The interaction information may identify that a foot and/or other body part, of the operator, is included in the interaction.

Alternatively or additionally, the interaction information received, in response to detecting the fuel pedal press, may identify a measure of interaction with a brake in first automotive vehicle 502a. The press of the fuel pedal may indicate a higher level of interaction with one component than another. Interaction information may identify a relative measure of interaction, an absolute measure of interaction, an activity of an operator and/or an object included in an interaction, and/or an activity that an operator and/or object is not engaged in.

In FIG. 4a, interaction monitor component 402a is illustrated as a component of attention subsystem 403a. In FIG. 4b, interaction monitor component 402b is illustrated as component of safety service 403b. Various adaptations and analogs of interaction monitor component 302 in FIG. 3, such as interaction monitor components 402 in FIGS. 4a-b, may monitor an operator of, for example, first automotive vehicle 502a by receiving interaction information from an input device. Either or both automotive vehicles 502 may include an instance and/or analog of execution environment 401a and an instance and/or analog of interaction monitor component 402a.

The input device may be included in the monitored first automotive vehicle 502a, may operate in another automotive vehicle illustrated by second automotive vehicle 502b, or may operate in a node that is not included in an automotive vehicle illustrated by service node 504. For example, an infrared sensing device in second automotive vehicle 502b may receive interaction information about an interaction including the operator of first automotive vehicle 502a based on thermal information captured by the infrared sensing device. In another example, a series of sensors in a road may be included in node 504 and/or operatively coupled to node 504. The sensors may provide interaction information to interaction monitor component 402b in FIG. 4b operating in service node 504. Interaction monitor component 402b may be configured to receive interaction information by detecting a pattern of movement in a lane of a road and/or speed changes over a path of travel. A speed and/or pattern of movement with respect to a lane in a road may be included in determining a measure of interaction with a steering wheel for the operator of an automotive vehicle 502.

Interaction information may include and/or may otherwise be based on interaction information received in response to any input and/or group of inputs that may be included in determining whether an interaction is occurring and/or has just occurred between an operator and one or more operational components of an automotive vehicle 502, such as steering wheel, a gauge, a viewport, a pedal, a lever, and the like.

The term “operational component”, as used herein, refers to a component included in operating an automotive vehicle. The term “operating information” as used herein refers to any information that identifies an operational attribute of an operating device or a portion thereof. An automotive vehicle is one type of device. Operating information for an automotive vehicle may identify a speed, a direction, a route, an acceleration, a rate of rotation of a part, a location, a measure of heat, a measure of pressure, a weight, a mass, a measure of force, an ambient condition for some or all of the automotive vehicle, an attribute of the automotive vehicle's operator, a measure of traffic including the automotive vehicle, a measure of fuel and/or other fluid included in operating of the automotive vehicle, an attribute of an executable operating in an execution environment of the automotive vehicle, and the like. For example, data that identifies a vector or path of movement of second automotive vehicle 502b may be included in and/or otherwise identified by operating information. In another example, operating information may identify a state of a cruise control subsystem of an automotive vehicle 502. In an aspect, the state may identify interaction information for a fuel pedal and/or speedometer of the automotive vehicle 502.

In an aspect, interaction information for a particular operational component in an automotive vehicle 502 may be received based on a lack of input detected by an input device and/or by detecting input included in an activity and/or directed to an object not included in operating the automotive vehicle 502. For example, a gaze detector for detecting visual interaction with a left, front window of first automotive vehicle 502a may not detect the gaze of the operator of first automotive vehicle 502a at a particular time and/or during a specified time period. Interaction information indicating no interaction with the left, front window may be received by interaction monitor component 402a in FIG. 4a from the gaze detector. The gaze detector may be included in first automotive vehicle 502a. The interaction information may be received by the interaction monitor component 402a operating in first automotive vehicle 502a and/or by may be received, via a network, by an interaction monitor component 402a operating in second automotive vehicle 502b. In another aspect, the gaze detector may be included in first automotive vehicle 502a and an interaction monitor component 402b may operate in an instance of execution environment 401b in service node 504 to receive the interaction information.

Interaction monitor components 402 in FIG. 4a and/or in FIG. 4b may include and/or otherwise interoperate with a variety of input devices to receive interaction information. In an aspect, a radio dial included in first automotive vehicle 502a may receive input from an operator of first automotive vehicle 502a indicating a spatial direction of an object included in an interaction with the operator, such as a window to the left of the operator. Interaction monitor component 402a may receive interaction information in response to the detected radio dial input indicating a physical movement of the operator of first automotive vehicle 502a. Input received via other input controls may result in interaction information detectable by an interaction monitor component 402. Exemplary input controls include buttons, switches, levers, toggles, sliders, lids, door handles, and seat adjustment controls.

Interaction monitor components 402 in FIG. 4a and/or in FIG. 4b may detect and/or otherwise receive interaction information identifying a measure of interaction, determined based on a specified metric that indicates a degree or level of interaction between an operator, driving an automotive vehicle 502, and an operational component and/or other object in the automotive vehicle 502. For example, a sensor in a headrest in first automotive vehicle 502a may detect an operator's head contacting the headrest. The sensor may detect a length of time of contact with the headrest, a measure of pressure received by the headrest from the contact, a number of contacts in a specified period of time, and/or a pattern of contacts detected over a period of time. The sensor in the headrest may include an interaction monitor component 402a, may be included in an interaction monitor component 402a, and/or may be operatively coupled to an interaction monitor component 402a in first automotive vehicle 502a, an interaction monitor component 402a in second automotive vehicle 502b, and/or interaction monitor component 402b operating in service node 504. Interaction information received by and/or from the sensor in the headrest may identify and/or may be included in determining a measure of interaction between the operator and a steering wheel. For example, the sensor may detect head motions associated with a sleepy and/or otherwise impaired operator. Interaction monitor component 402a in first automotive vehicle 502a may be configured to detect a lower measure of interaction between the operator and the steering wheel and/or other operational components than would otherwise be detected based on the interaction information received from the sensor in the headrest.

An interaction monitor component 402 may detect and/or otherwise receive interaction information based on other parts of an operator's body. Interaction information may be received by an interaction monitor component 402a and/or interaction monitor component 402b based on an eye, an eyelid, a head, a chest, an abdomen, a back, a leg, a foot, a toe, an arm, a hand, a finger, a neck, skin, and/or hair; and/or portion of an operator and/or another occupant's body that is monitored. An interaction monitor component 402 may detect and/or otherwise receive interaction information identifying, for a part or all of an operator a direction of movement, a distance of movement, a pattern of movement, and/or a count of movements.

In an aspect, a gaze detector included in first automotive vehicle 502a may detect the operator's eye movements to determine a direction of focus and/or a level of focus indicating visual interaction between the operator and one or more operational components, such as a viewport providing a view. The indicated visual interaction may measure and/or otherwise identify no or low interaction with another viewport and/or other operational component in another direction. Interaction monitor component 402a in FIG. 4a may include and/or otherwise be operatively coupled to the gaze detector. One or more gaze detectors may be included in one or more locations in first automotive vehicle 502a for detecting interaction with a windshield of first automotive vehicle 502a, a brake pedal, a mirror, a gear shift, a display, and/or a rear window, to name some exemplary operational components. Alternatively, one or more gaze detectors may be included in first automotive vehicle 502a to monitor inputs for detecting interaction between the operator and an object other than an operational component of first automotive vehicle 502a. For example, a gaze detector may detect visual interaction with a radio, a glove box, a heating and ventilation control, and/or to another occupant. In another aspect, a gaze detector in first automotive vehicle 502a may be communicatively coupled to interaction monitor component 402b operating in service node 504 via network 506. Alternatively or additionally, the gaze detector in first automotive vehicle 502a may be communicatively coupled to an instance or analog of an interaction monitor component 402a operating in second automotive vehicle 502b via network 506. A gaze detector and/or motion sensing device may be at least partially included in an automotive vehicle 502 and/or at least partially on and/or in an operator of the automotive vehicle 502. For example, an operator may wear eye glasses and/or other gear that includes a motion sensing device detecting direction and/or patterns of movement of a head and/or eye of the operator.

An interaction monitor component 402 in FIG. 4a and/or in FIG. 4b may receive interaction information for an operational component in and/or another object in or external to an automotive vehicle 502, such as a screen of a display device of a personal electronics device (PED) of the operator of the automotive vehicle 502, by receiving interaction information from the PED in response to user interaction with the PED.

Alternatively or additionally, interaction monitor component 402 in FIG. 4a and/or in FIG. 4b may include and/or otherwise may communicate with other attention sensing devices. An interaction monitor component 402 may interoperate with various types of head motion sensing devices included in an automotive vehicle 502 and/or worn by the operator. Parts of an automotive vehicle 502 may detect touch input directly and/or indirectly including depressible buttons, rotatable dials, multi-position switches, and/or touch screens. A seat may be included that detects body direction and/or movement. A headrest may detect contact and thus indicate a head direction and/or level of attention of an operator. An automotive vehicle 502 may include one or more microphones for detecting sound and determining a direction of a head of operator. Other sensing devices that may be included in an automotive vehicle 502, included in the operator, and/or attached to the operator include galvanic skin detectors, breath analyzers, other detectors of bodily emissions, and detectors of substances taken in by the operator such as alcohol.

FIG. 4b illustrates interaction monitor component 402b operating external to automotive vehicles 502. Interaction monitor component 402b operating in service node 504 may receive interaction information for an operator of one or both automotive vehicles 502 via network 506. Interaction monitor component 402b in FIG. 4b may receive interaction information from one or more of the sensing devices described above with respect to FIG. 4a. In an aspect, interaction monitor component 402b may receive interaction information for a first operator in first automotive vehicle 502a for detecting interaction with a first viewport providing a view of second automotive vehicle 502b operated by a second operator. Interaction monitor component 402b may similarly receive attention information for the second operator in second automotive vehicle 502b to detect interaction with a second viewport providing a view of first automotive vehicle 502a. Thus, an interaction monitor component along with other components in the arrangement may monitor and manage interactions of one or more operators of respective one or more automotive vehicles 502. Analogously, in an aspect, an interaction monitor component 402a in an automotive vehicle 502 may receive interaction information for operators in more than one automotive vehicle.

Interaction information may be provided to an interaction monitor component 402 for detecting whether an attention criterion is met for a viewport and/or other operational component. An attention criterion may be specified to identify that an operational component requires interaction and/or a change in interaction when the attention criterion is met. Interaction information may include and/or otherwise identify information for detecting whether and when an attention criterion is met. As used herein the term “attention criterion” refers to a criterion that when met indicates that an operational component is not included in adequate interaction with an operator according a specified metric for measuring interaction at a particular time and/or during a particular time period.

In an aspect, an interaction monitor component 402 in FIG. 4a and/or in FIG. 4b may determine that an attention criterion is met for a first viewport, in response to determining whether an attention criterion is met for a second viewport. An attention criterion may be specified based on a measure of interaction. An attention criterion may be predetermined for a viewport or may be associated with the viewport dynamically based on a specified condition. Different viewports may be associated with different attention criteria. In another aspect, an attention criterion may be associated with more than one viewport. Different attention criteria may be based on a same measure of interaction and/or metric for determining a measure of interaction. In another aspect different attention criteria may be based on different measures of interaction and/or different metrics. A measure and/or metric for determining whether an attention criterion is met may be pre-configured and/or may be determined dynamically based on any information detectable within an execution environment hosting some or all of an adaptation and/or analog of the arrangement of components in FIG. 3.

In various aspects, whether an attention criterion is met or not for an operational component may be based on an attribute of the operational component, an attribute of another operational component, an attribute of an operation enabled or performed by an operational component of an automotive vehicle, an operator of an automotive vehicle, an attribute of one or more occupants of an automotive vehicle, an attribute of movement of an automotive vehicle, a location of an automotive vehicle, and/or an ambient condition in and/or outside an automotive vehicle, to name a few examples. Predefined and/or dynamically determined values may be included in determining whether an attention criterion for an operational component is met or not For example, one or more of a velocity of an automotive vehicle, a rate of acceleration, a measure of outside light, a traffic level, and/or an age of an operator of the automotive vehicle may be included in determining whether an attention criterion for an operational component is met.

In an aspect, an attention criterion may identify an interaction threshold based on a metric for measuring interaction. When a measure of interaction is determined to have crossed the identified threshold, the attention criterion may be defined as met.

In another aspect, interaction monitor component 402a in FIG. 4a and/or interaction monitor component 402b in FIG. 4b may interoperate with a timer component, such as clock component 423a, in FIG. 4a, to set a timer at a particular time with a given duration. The particular time may be identified by configuration information. For example, a timer may be set at regular intervals and/or in response to one or more specified events such as a change in speed and/or direction of an automotive vehicle. A timer may be set in response to receiving interaction information. For example, interaction monitor component 402a may detect visual interaction between an operator and a front windshield of first automotive vehicle 502a. In response, interaction monitor component 402a may instruct clock component 423a to start a timer for detecting whether an attention criterion is met for a rear-view mirror.

In various aspects, adaptations and analogs of interaction monitor component 302 may detect an expiration of a timer as indicating an attention criterion is met, since the time was not cancelled. In other aspect, an expiration of timer may indicate that an attention condition is not met. Thus, an attention criterion may be based on time. A time period may be detected indirectly through detecting the occurrence of other events that bound and/or otherwise identify a start and/or an end of a time period. Time periods may have fixed and/or may have varying durations.

Time may be measured in regular increments as is typical, but may also be measured by the occurrence of events that may be occur irregularly over a given period as compared to the regularity of, for example, a processor clock. For example, time may be measured in distance traveled by an automotive vehicle 502, a measure of time may be based on a velocity of an automotive vehicle 502, input events detected by one or more components of an automotive vehicle 502, and/or time may be measured in terms of detected objects external to an automotive vehicle 502 such as another moving automotive vehicle 502.

In an aspect, determining whether an attention criterion is met may include detecting a specified time period indicating that the attention criterion is to be tested. For example, a timer may be set to expire every thirty seconds to indicate that an attention criterion for a side-view mirror is to be tested. In another example, a start of a time period may be detected in response to interaction monitor component 402b receiving interaction information including a first indicator of visual attention. An end of the time period may be detected in response to interaction monitor component 402b receiving interaction information including a subsequent indicator of visual attention. Interaction monitor component 402b may measure a duration of the time period based on receiving the first indicator and the subsequent indicator.

Alternatively or additionally, determining whether an attention criterion is met or not may include detecting a time period during which no input is detected that would indicate an operator is interacting with a particular viewport for at least a portion of the time period. The time period and/or portion thereof may be defined by a configuration of a particular interaction monitor component 402. For example, the time period and/or the portion may be defined based on detecting that a particular number of indicators of visual interaction are received and/or based on a measure of time between receiving indicators of visual interaction.

Alternatively or additionally, detecting that an attention criterion is met may include detecting interaction with something other than the operational component for at least a portion of the time period. As similarly described in the previous paragraph, the time period and/or the portion thereof, where attention is directed to something other than the operational component, may be defined by a configuration of a particular interaction monitor component 402. The time period and/or the portion thereof may be defined based on detecting a particular number of indicators of visual interaction received and/or based on a measure of time between receiving indicators of visual interaction.

In various aspects, adaptations and analogs of interaction monitor component 304 in FIG. 3 may receive and/or otherwise evaluate an attention criterion. An attention criterion may be tested and/or otherwise detected based on a duration of a detected time period. That is the attention criterion may be time-based. An attention criterion may be selected and/or otherwise identified from multiple attention criteria for testing based on a duration of a detected time period.

A measure of the duration of a time period may be provided as input for testing and/or otherwise evaluating an attention criterion by interaction monitor component 402a in FIG. 4a and/or interaction monitor component 402b in FIG. 4b. A variety of criteria may be tested in various aspects. An attention criterion may specify a threshold length for a duration for testing to determine whether the time period duration matches and/or exceeds the threshold duration. A threshold in an attention criterion may be conditional. That is, the threshold may be based on a view, an object visible in a view, a particular occupant, a speed of an automotive vehicle, another vehicle, a geospatial location of an automotive vehicle, a current time, a day, a month, and/or an ambient condition, to name a few examples.

An attention criterion may be evaluated relative to another attention criterion. In FIG. 4a, interaction monitor component 402a may test a first attention criterion for a first view that includes a comparison with an attention criterion for a second viewport. In FIG. 4b, interaction monitor component 402b may detect a first attention criterion is met for a first viewport when a second attention criterion for a second viewport is not met.

In still another aspect, interaction monitor component 402a may receive and/or identify a measure of interaction based on a first duration of a first time period. For example, interaction monitor component 402a may determine a ratio of the first duration to a second duration in a second time period. An attention criterion for a side-view mirror may specify that the attention criterion is met when the ratio of a first measure of interaction, based on a duration of a first time period for the side-view mirror, to a second measure of interaction based on a duration of a second time period for a rear-view mirror, is at least two or some other specified value.

An attention criterion may be evaluated based on detecting the occurrence of one or more particular events. For example interaction monitor component 402b in FIG. 4b may evaluate an attention criterion for a rear window of an automotive vehicle 502. The attention criterion for the rear window may specify that the criterion is met only when automotive vehicle is moving in a reverse direction and/or otherwise is in a reverse gear.

In an aspect, interaction information may be detected based on a policy defining an operational condition of one or more components that when met identifies interaction information. For example, a detected turn by an automotive vehicle 502 with no detected corresponding turn signal or an incorrect turn signal may indicate that interaction information is to be sent to an interaction monitor component.

In another aspect, a user may report interaction information to be communicated to one or more interaction monitor components 402 in one or more automotive vehicles 502 and/to one or more service nodes 504. A user may report interaction information based on observation of an automotive vehicle and/or an operator. A user may report interaction information based on knowledge of an automotive vehicle, such as a known condition of a brake pad, and/or based on knowledge of an operator, such as a disability, a medication effect, sleepiness, observed activity of the operator, an ambient condition for the operator, and/or intoxicated state of the operator.

Returning to FIG. 2, block 204 illustrates that the method further includes detecting a second automotive vehicle, wherein the second automotive vehicle is operated by a second operator. Accordingly, a system for altering attention of an automotive vehicle operator includes means for detecting a second automotive vehicle, wherein the second automotive vehicle is operated by a second operator. For example, as illustrated in FIG. 3, vehicle detector component 304 is configured for detecting a second automotive vehicle, wherein the second automotive vehicle is operated by a second operator. FIGS. 4a-b illustrate vehicle detector component 404 as adaptations and/or analogs of vehicle detector component 304 in FIG. 3. One or more vehicle detector components 404 operate in execution environments 401.

“Vehicle information” as used herein is information that identifies and/or otherwise enables the detection of an automotive vehicle. For example, vehicle information may include and/or otherwise provide access to an automotive vehicle's manufacturer, model, and/or model year. Alternatively or additionally vehicle information may identify an automotive vehicle by identifying a part and/or attribute of a part of the automotive vehicle, an attribute of the operator, operating information for the automotive vehicle, interaction information for the automotive vehicle, and/or presence information for the automotive vehicle.

In FIG. 4a, vehicle detector component 404a is illustrated as a component of attention subsystem 403a. In FIG. 4b, vehicle detector component 404b is illustrated as a component of safety service 403b. A vehicle detector component 404 may be adapted to receive vehicle information in any suitable manner, in various aspects. For example receiving vehicle information may include receiving a message via network, receiving data via a communications interface, detecting a user input, sending a message via a network, receiving data in response to data sent via a communications interface, receiving data via user interaction with a presented user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt.

In an aspect, illustrated in FIG. 4a, vehicle detector component 404a may receive vehicle information in response to an operator input detected by input driver component 421a interoperating with an input device adapter, as described with respect to FIG. 1. For example, a key may be detected when inserted into an ignition switch in first automotive vehicle 502a. An execution environment 401a illustrated in FIG. 4a, may operate in first automotive vehicle 502a. Vehicle detector component 404a may identify and/or otherwise detect first automotive vehicle 502a in response to detecting insertion of the key and/or as part of a process for initiating operation of first automotive vehicle 502a. A vehicle detector component 404a operating in an automotive vehicle 502 may be preconfigured to detect the automotive vehicle 502 in which it is operating.

In another aspect, vehicle information may include and/or otherwise identify operational information detected via an input device such as heat sensor in an automotive vehicle. First automotive vehicle 502a, in FIG. 5, may include an infrared heat sensor for detecting heat from operating automotive vehicles, such as second automotive vehicle 502b, in range of the sensor. The heat sensor may interoperate with a vehicle detector component 402a to detect sufficient heat from second automotive vehicle 502b to detect that second automotive vehicle is operating. The vehicle detector component may operate in first automotive vehicle as just described, in second automotive vehicle 502b, and/or in a node not included in an automotive vehicle, such as service node 504. In yet another aspect, second automotive vehicle 502b may detect its own operation via a heat detecting sensor detecting heat from an operational component of second automotive vehicle 502b. The sensor may interoperate with a vehicle detector component 402a operating in second automotive vehicle 502b and/or may interoperate with a vehicle detector component 402b not included in second automotive vehicle 502b via a network.

In another aspect, an instance or analog of execution environment 401a in FIG. 4a may operate in second automotive vehicle 502b. Vehicle detector component 402a may receive vehicle information in a message received via network stack 407a and optionally via application protocol component 409a. Second automotive vehicle 502b may request vehicle information via a network such as network 506 including first automotive vehicle 502a and second automotive vehicle 502b. Alternatively or additionally, second automotive vehicle 502b may listen for a heartbeat message via a wireless receiver in a network adapter indicating first automotive vehicle 502a is in range of the wireless network. Alternatively or additionally, safety service 403b may interoperate with a network interface adapter and/or network stack 407b to activate listening for the heartbeat message. Network 506 may be LAN with limited range. Automotive vehicles 502 may be detected by vehicle detector component 404b based on one or more received messages in response to being in a location defined by the range of the LAN. In another aspect, safety service 403b may send a request or heartbeat message. An automotive vehicle 502 may be configured to detect the message and send a message in response including and/or otherwise identifying vehicle information for detecting the automotive vehicle. Safety service 403b may provide the received vehicle information to vehicle detector component 402b for detecting the automotive vehicle 502b as operating in range of service node 504.

Alternatively or additionally, a vehicle detector component 402 may receive vehicle information via an input device such as a radar device (not shown). A signal sent from second automotive vehicle 502b may be reflected by first automotive vehicle 502b. The reflection may be received by the radar device. Vehicle information for first automotive vehicle 502a may be generated by the radar device and provided to vehicle detector component 404a. Vehicle detector component 404a operating in second automotive vehicle 502b may detect first automotive vehicle 502a based on the vehicle information. Analogously, service node may detect and/or otherwise identify one or both vehicles 502 via a radar device in and/or operatively coupled to service node 504. Vehicle information for one or both automotive vehicles 502 may be provided to vehicle detector component 404b for respectively identifying one or both automotive vehicles 502.

Receiving vehicle information may include receiving the vehicle information via a physical communications link, a wireless network, a local area network (LAN), a wide area network (WAN), and/or an internet. Vehicle information may be received via any suitable communications protocol, in various aspects. Exemplary protocols include a universal serial bus (USB) protocol, a BLUETOOTH protocol, a TCP/IP protocol, hypertext transfer protocol (HTTP), a remote procedure call (RPC) protocol, a protocol supported by a serial link, a protocol supported by a parallel link, and Ethernet. Receiving vehicle information may include receiving a response to a request previously sent via a communications interface. Receiving vehicle information may include receiving the vehicle information in data transmitted asynchronously. An asynchronous message is not a response to any particular request and may be received without any associated previously transmitted request.

In yet another aspect, illustrated in FIG. 4b, network application platform component 405b may receive vehicle information in a message transmitted via network 506. The message may be routed within execution environment 401b to vehicle detector component 404b by network application platform 405b. For example, the message may include a universal resource identifier (URI) that network application platform 405b is configured to associate with vehicle detector component 404b. In an aspect, an automotive vehicle 502 may send vehicle information to service node 504 via network 506. In another aspect, safety service 403b may be configured to monitor one or more automotive vehicles including automotive vehicles 502. A component of safety service 403b, such as vehicle detector component 404b, may periodically send respective messages via network 506 to automotive vehicles 502 requesting vehicle information. Automotive vehicles 502 may respond to the respective requests by sending corresponding response messages including vehicle information. The response messages may be received and the vehicle information may be provided to vehicle detector component 404b as described above or in an analogous manner.

Returning to FIG. 2, block 206 illustrates that the method yet further includes determining, based on the interaction information, attention information for identifying an attention output. Accordingly, a system for altering attention of an automotive vehicle operator includes means for determining, based on the interaction information, attention information for identifying an attention output. For example, as illustrated in FIG. 3, attention control component 306 is configured for determining, based on the interaction information, attention information for identifying an attention output. FIGS. 4a-b illustrate attention control component 406b as adaptations and/or analogs of attention control component 306 in FIG. 3. One or more attention control components 406b operate in execution environments 401.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by an IPU to present an attention output. The aspects described serve merely as examples based on the definition of attention information, and do not provide an exhaustive list of suitable forms and content of attention information.

In various aspects, attention control component 306 in FIG. 3 and its adaptations, may be configured to identify, generate, and/or otherwise determine attention information in any suitable manner. For example determining attention information may include receiving a message via network, receiving data via a communications interface, detecting a user input, sending a message via a network, receiving data in response to data sent via a communications interface, receiving data via user interaction with a presented user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt.

An attention control component 406 in FIG. 4a and/or in FIG. 4b may identify and/or otherwise determine attention information based on interaction information received by an interaction monitor component 402. In one aspect, an attention control component 406 may automatically generate attention information in response to an instruction and/or indication from an interaction monitor component 402 that interaction information has been received.

In another aspect, an attention control component 406 may determine attention information in response to and/or otherwise based on detecting an automotive vehicle 502 as described above. In still another aspect, an attention control component 406 may determine attention information based on some other specified event. For example, attention control component 406b in FIG. 4b may receive an indication of and/or may detect that an attention criterion for an operational component of first automotive vehicle 502a is met, as described above. Interaction monitor component 402b and/or attention control component 406b may identify that the attention criterion is met. In a further aspect, detecting that the attention criterion is met may occur prior to determining attention information. Determining attention information may be based on detecting that a particular attention criterion is met.

For example, interaction information for first automotive vehicle may identify changes in speed in a given time period for first automotive vehicle 502a operated by a first operator. The interaction information may identify a number of changes in speed, a standard deviation for the changes, a range for the changes, and/or the like. The interaction information may be received by interaction monitor component 402b. A configured attention criterion may identify a threshold of speed changes, a range for a standard deviation, and/or a threshold for a difference between a maximum speed and a minimum speed identified in a range. The attention criterion may be evaluated by attention control component 406b based on the interaction information received. Attention control component 406b may interoperate with interaction monitor component 402b in evaluating the attention criterion. The interaction information may be processed as input for determining whether specified attention criterion is met and/or may trigger the identification and evaluation of the attention criterion. If the attention criterion is met, attention control component 406b may be configured to generate, locate, and/or otherwise determine attention information. The attention information may be determined based on the interaction information and/or based on the met attention criterion. The attention information may identify an operational component for the operator to interact with and/or otherwise alter an interaction with.

An attention criterion may be based on a length of time that an operational status and/or operator status of an automotive vehicle 502 has existed. For example, an attention criterion for a first operational component of first automotive vehicle 502a may be based on a speed at which first automotive vehicle 502a is approaching second automotive vehicle 502b and/or based on a distance between the two automotive vehicles 502.

An attention criterion for a second operational component in first automotive vehicle 502a may be based on a length of time since interaction between the operator the second operational component was last detected. The first operational component may be a front windshield and the second operational component may be a steering wheel. An attention criterion may be selected and/or otherwise identified from multiple attention criteria for determining whether and/or what attention information is to be generated. The selection of an attention criterion may be predefined or may be determined dynamically based on a configuration of a particular attention control component 406.

Attention information may be coded into an attention control component 406 and/or may be received as configuration information by an attention control component 406. A variety of attention criteria may be tested and/or evaluated in various aspects in determining whether and what attention information is to be generated and/or otherwise determined.

In another aspect, an attention control component 406 may determine a ratio of a length of time associated with a first attention criterion for an operator of an automotive vehicle to a length of time associated with a second attention criterion associated with an another operator of another automotive vehicle. For example, an attention control component 406 may be configured to determine attention information for first automotive vehicle 502a approaching from the rear of second automotive vehicle 502b instead of or before determining attention information based on a third automotive vehicle (not shown) approaching second automotive vehicle 502b from the front when an attention criterion for the operator of first automotive vehicle 502a has been met for a longer time than an attention criterion for the operator of the third automotive vehicle.

Returning to FIG. 2, block 208 illustrates that the method yet further includes sending the attention information for presenting the attention output, by an output device, to alter a second interaction that includes the second operator. Accordingly, a system for altering attention of an automotive vehicle operator includes means for sending the attention information for presenting the attention output, by an output device, to alter a second interaction that includes the second operator. For example, as illustrated in FIG. 3, attention director component 308 is configured for sending the attention information for presenting the attention output, by an output device, to alter a second interaction that includes the second operator. FIGS. 4a-b illustrate attention director component 408 as adaptations and/or analogs of attention director component 308 in FIG. 3. One or more attention director components 408 operate in execution environments 401.

In various aspects, attention director component 308 in FIG. 3 and its adaptations, such as attention director component 408a in FIG. 4 and attention director component 408b in FIG. 4b, may be configured to send attention information in any suitable manner. For example, sending attention information may include receiving a message via network, receiving data via a communications interface, detecting a user input, sending a message via a network, receiving data in response to data sent via a communications interface, receiving data via user interaction with a presented user interface element, interoperating with an invocation mechanism, interoperating with an interprocess communication (IPC) mechanism, accessing a register of a hardware component, receiving data in response to generating a hardware interrupt, responding to a hardware interrupt, receiving data in response to generating a software interrupt, and/or responding to a software interrupt.

In FIG. 4a, attention director component 408a may interoperate with a UI element handler component 411a to send attention information including presentation information representing the attention output to an output device to present the attention output. The attention output is presented to an operator of an automotive vehicle 502 to alter an interaction that the operator is included in. Altering an interaction may include starting the interaction, stopping the interaction, and/or changing some attribute of the interaction such as changing an amount of data exchanged in the interaction. An attention output may include changing an attribute of attention of the operator. In one aspect, the attention output may be presented attract, instruct, and/or otherwise direct attention from the operator of second automotive vehicle 502b to interact with a viewport including a view of first automotive vehicle 502a.

The term “attention output” as used herein refers to a user-detectable output to attract, instruct, and/or otherwise direct an operator of an automotive vehicle to initiate, end, and/or otherwise alter an interaction that includes the operator and an operational component of the automotive vehicle operated by the operator. The operational component may be a particular viewport, a braking control mechanism, steering control mechanism, and the like, as described above.

A UI element handler component 411a in and/or otherwise operatively coupled to attention director component 408a may send, based on received attention information, presentation information for presenting an attention output by invoking presentation controller 413a to interoperate with an output device via presentation subsystem 419a, as described above. Presentation controller 413a may be operatively coupled, directly and/or indirectly, to a display, a light, an audio device, a device that moves such as seat vibrator, a device that emits heat, a cooling device, a device that emits an electrical current, a device that emits an odor, and/or another output device that presents an output that may be sensed by the operator.

An attention output may be represented by one or more attributes of a user interface element(s) that represent one or more operational components. For example, attention director component 408a may send color information to present a color on a surface, such as display screen, of automotive vehicle 502b. The color may be presented in a UI element representing a viewport of second automotive vehicle 502b that provides a view of first automotive vehicle 502a to direct the operator of second automotive vehicle 502b to interact with the viewport to see first automotive vehicle 502b via the viewport. A first color may identify a higher attention output with respect to a lesser attention output based on a second color. For example, red may be defined as higher priority than orange, yellow, and/or green.

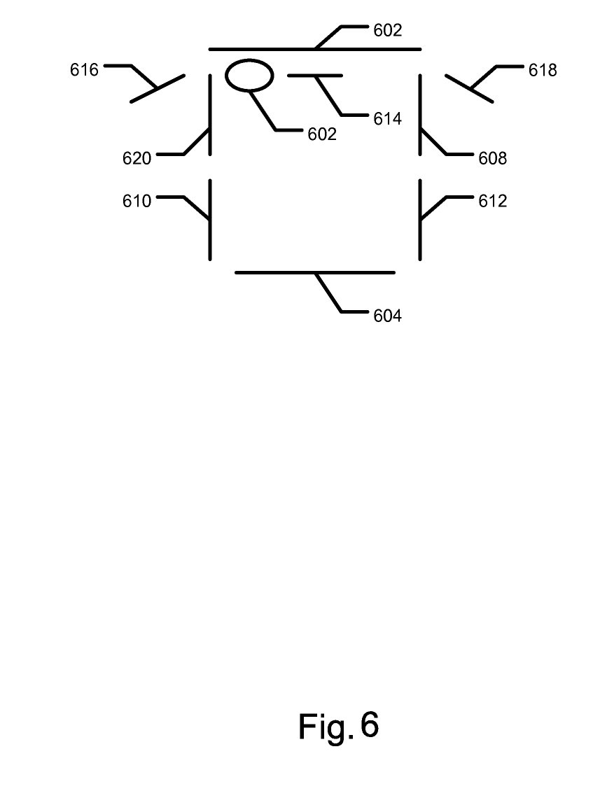

FIG. 6 illustrates user interface elements representing viewport operational components to an operator and/or another occupant of an automotive vehicle. A number of viewports are represented in FIG. 6 by respective line segment user interface elements. The presentation in FIG. 6 may be presented on a display in a dashboard, on a sun visor, in a window, and/or on any suitable surface of an automotive vehicle 502. FIG. 6 illustrates front indicator 602 representing a viewport including a windshield of the automotive vehicle 502, rear indicator 604 representing a viewport including a rear window, front-left indicator 606 representing a viewport including a corresponding window when closed or at least partially open, front-right indicator 608 representing a viewport including a front-right window, back-left indicator 610 representing a viewport including a back-left window, back-right indicator 612 representing a viewport including a back-right window, rear-view display indicator 614 representing a viewport including a rear-view mirror and/or a display device, left-side display indicator 616 representing a viewport including a left-side mirror and/or display device, right-side display indicator 618 representing a viewport including a right-side mirror and/or display device, and display indicator 620 representing a viewport including a display device in and/or on a surface of automotive vehicle 502. The user interface elements in FIG. 6 may be presented via the display device, represented by display indicator 620.

Attention information representing an attention output for an operational component may include information for changing a border thickness in a border in a user interface element in and/or surrounding some or all of the operational component and/or a surface of the operational component. For example, to attract attention to first automotive vehicle 502a viewable via the front-left mirror of second automotive vehicle 502b, attention director component 408a may send presentation information to presentation controller 413a to present front-left indicator 616 with a thickness that is defined to direct the operator of second automotive vehicle 502b to interact with the left-side mirror and/or to otherwise change the operator's interaction with the left-side mirror to look at first automotive vehicle 502a via the left-side mirror. A border thickness may be an attention output and a thickness and/or thickness relative to another attention output may identify an attention output as a higher attention output or a lesser attention output.

A visual pattern may be presented via a display device. The pattern may direct an operator of second automotive vehicle 502b to initiate, end, and/or otherwise alter an interaction between the operator and an operational component such as a speedometer and/or a viewport indicating a direction of motion of second automotive vehicle 502b in response to interaction information indicating an operator of first automotive vehicle 502a is directing insufficient attention to an operational component of first automotive vehicle 502a. In an aspect, a sensor in first automotive vehicle 502a, in second automotive vehicle 502b, and/or a sensor not in either automotive vehicle may have detected first automotive vehicle 502a outside an appropriate lane in the road. Attention director component 408b in service node 504 may send a message including the attention information, via network 506 to second automotive vehicle 502b. Alternatively or additionally, an instance of attention director component 408a operating in first automotive vehicle 502a may send attention information to second automotive vehicle 502b to present an attention output to the operator of second automotive vehicle 502b.

In another aspect, a light in second automotive vehicle 502b and/or a sound emitted by an audio device in second automotive vehicle 502b may be defined to correspond to an operational component such as brake, a gauge, a dial, a turn signal control, a cruise control input mechanism, and the like. The light may be turned on to cause the operator to interact with the brake to slow second automotive vehicle 502b and/or the sound may be output for the same and/or a different operational component. The light may identify the brake as a higher priority operational component with respect to another operational component without a corresponding light or other attention output.

In another aspect, attention information may be sent to end an attention output. For example, the light and/or a sound may be turned off and/or stopped.

An attention output to alter an interaction including an operator may provide relative information relative to another attention output, as described above. In an aspect, attention outputs may be presented based on a multi-point scale providing relative indications of a need for an operator's attention to interacting with respective operational components. Higher priority or lesser priority may be identified based on the points on a particular scale. A multipoint scale may be presented based on text such as a numeric indicator and/or may be graphical, based on a size or a length of the indicator corresponding to a priority ordering.

For example, a first attention output may present a first number based on interaction information for first automotive vehicle 502a to an operator of second automotive vehicle 502b. A second attention output may include a second number for a third automotive vehicle (not shown). A number may be presented to alter a direction, level, and/or other attribute of an interaction that includes the operator. The size of the numbers may indicate a ranking or priority of one automotive vehicle over another. For example, if the first number is higher than the second number, the scale may be defined to indicate that one interaction and/or change in an interaction is more important than another.

A user interface element, including an attention output, may be presented by a library routine of GUI subsystem 415a. Attention director component 408b may change a user-detectable attribute of the UI element. For example, attention director component 408b in service node 504 may send attention information via network 506 to second automotive vehicle 502b for presenting an attention output by an output device of automotive vehicle 502b. An attention output may include information for presenting a new user interface element and/or to change an attribute of an existing user interface element to alter an interaction including the operator of second automotive vehicle 502b.

A region of a surface in automotive vehicle 502 may be designated for presenting an attention output. As described above a region of a surface of automotive vehicle 502b may include a screen of a display device for presenting the user interface elements illustrated in FIG. 6. A position on and/or in a surface of automotive vehicle 502b may be defined for presenting an attention output for a particular operational component identified by and/or with the position. In FIG. 6, each user interface element has a position relative to the other indicators. The relative positions identify respective operational components. A portion of a screen in a display device may be configured for presenting one or more attention outputs.

An attention director component 408 in FIG. 4a and/or in FIG. 4b may provide an attention output that indicates how soon an operational component requires an change in interaction with the an operator. For example, attention director component 408a may send attention information identifying an attention output directing the operator of second automotive vehicle 502b to interact with a viewport within a specified period of time in order to see first automotive vehicle 502a. Thus, an attention output may be presented to alter a temporal attribute of an interaction. Changes in size, location, and/or color of a UI element may indicate whether an operational component requires interaction and may give an indication as to how soon an operational component may need interaction and/or may indicate a level of interaction suggested and/or required. An attention output may identify a time of day and/or an indication relative to a time of day and/or some other event.

In FIG. 4b, attention director component 408b in safety service 403b may send information via a response to a request and/or via an asynchronous message to a client, such as attention subsystem 403a and/or may exchange data with one or more input and/or output devices in one or both automotive vehicles 502 directly and/or indirectly to receive and/or to send attention information.

Attention director component 408b may send attention information in a message via network 506 to an automotive vehicle 502 for presenting by a presentation controller 413a of the automotive vehicle 502 via an output device. Presentation controller 413a may be operatively coupled to a projection device for projecting a user interface element as and/or including an attention output on a windshield of the automotive vehicle 502 to alter an interaction of the operator with the windshield and/or some other object. An attention output may be included in and/or may include one or more of an audio interface element, a tactile interface element, a visual interface element, and an olfactory interface element.

Attention information may include time information identifying a duration for presenting an attention output for a change in an interaction. For example, first automotive vehicle 502a may be detected approaching second automotive vehicle 502b. An attention output may be presented by attention director component 408a in FIG. 4a for maintaining interaction between the operator of second automotive vehicle 502b to one or more operational components based on interaction information for first automotive vehicle 502a. For example, an attention output may be presented to maintain an interaction with a viewport including a view of the approaching first automotive vehicle 502a. The attention output may be presented for an entire duration of time that first automotive vehicle 502a is approaching automotive vehicle 502b or for a specified portion of the entire duration.

A user-detectable attribute and/or element of an attention output may be defined to identify and/or instruct an operator to alter an interaction that includes the operator. For example, in FIG. 6 each line segment is defined to identify a particular operational component. A user-detectable attribute may include one or more of a location, a pattern, a color, a volume, a measure of brightness, and a duration of a UI element. A location may be one or more of in front of, in, and behind a surface of the automotive vehicle coupled to an operational component. A location may be adjacent to an operational component and/or otherwise in a specified location relative to a corresponding operational component and/or representation of the operational component. An attention output may include a message including one or more of text data and voice data.

The method illustrated in FIG. 2 may include additional aspects supported by various adaptations and/or analogs of the arrangement of components in FIG. 3. For example, in various aspects, interaction information may be received based on input detected by at least one of a gaze detector, a motion sensing device, a touch sensitive input device, and an audio input device. In an aspect, interaction monitor component 402a in FIG. 4a may include and/or otherwise be operatively coupled to a motion sensing device for detecting a hand motion near a compact disc player. An indicator of interaction information may be based on a motion detected by the motion sensing device for the compact disc player.

In another aspect, a directional microphone may detect voice activity from an operator and/or other occupant in first automotive vehicle 502a and provide interaction information to one or both of interaction monitor component 402a and interaction monitor component 402b. The microphone may be integrated in first automotive vehicle 502a, worn by the operator, and//or otherwise included in first automotive vehicle 502a.

An attention output may include and/or be identified with an input control for detecting an input from an automotive vehicle operator. An input control may be presented via an electronic display device or may be a hardware control. For example, an attention output may be associated with a button on a steering wheel. An operator of an automotive vehicle including the steering wheel may press the button to acknowledge a presented attention output.

Receiving interaction information, detecting an automotive vehicle, determining attention information, and/or sending attention information may be performed in response to user input received from an operator and/or another occupant in an automotive vehicle, a message received via a network, a communication received from a portable electronic device, and/or based on some other detected event. Exemplary events include insertion of a key in a lock, removal of a key, a change in motion, a change in velocity, a change in direction, identification of the operator, a change in a number of occupants, a change in an ambient condition, a change in an operating status of a component of the automotive vehicle, and/or a change in location of the automotive vehicle.

Interaction information may identify, for the operator, a direction relative to the operator of an object to interact with and/or included in an interaction, the object included in the interaction, and/or a measure of interaction based on a specified metric.

Interaction information received may be defined and/or otherwise based on an attribute of an occupant of the automotive vehicle, a count of occupants in the automotive vehicle, a count of audible occupants in the automotive vehicle, an attribute of the automotive vehicle, an attribute of a viewport, a speed of the automotive vehicle, a view viewable to the operator via a viewport, a direction of movement of at least a portion of the operator, a start time, an end time, a length of time, a direction of movement of an automotive vehicle, an ambient condition in the automotive vehicle for the operator, an ambient condition for the automotive vehicle, a topographic attribute of a location including the automotive vehicle, an attribute of a route of the automotive vehicle, information from a sensor external to the automotive vehicle, and/or information from a sensor included in the automotive vehicle. For example, interaction information may be based on a sound in an automotive vehicle. The interaction information may be based on a source of an audible activity that may attract an operator's attention, a change in volume of sound, and/or detection of an expected sound.

In an aspect, topographic information for a location of an automotive vehicle 502 may determine a time period and/or measure of visual interaction suitable to the topography of the location. A mountainous topography, for example, may be associated with a more sensitive method for detecting interaction information than a flat topography.

Receiving interaction information may include determining a measure of an audible activity in and/or external to the automotive vehicle. A measure of audible activity may be based on, for example, a number of audible active occupants in the automotive vehicle, a volume of an audio device, and/or unexpected sounds detected that may originate in and/or external to an automotive vehicle. Receiving interaction information may further include identifying one or more of a source and a location of a source of the audible activity. An interaction monitor component may receive audio interaction information from audio input devices on and/or otherwise near an operator and/or may receive interaction information based on inputs detected by multiple audio input devices for determining a source location via a triangulation technique based on a volume and/or relative time an audio activity is detected by one or more of the audio input devices. One or more audio input devices may provide interaction information to interaction monitor component 402b via network 506. Safety service 403b, in an aspect may receive audio interaction information in response to an audio input detected by an automotive vehicle 502. Interaction monitor component 402b may determine whether an attention criterion is met based on a criterion specification policy stored in policy data store 425b. For example, interaction information may be received based on audio input identifying a measured decibel level of audio activity detected in an automotive vehicle 502 that exceeds a level specified by the specified attention criterion.

In addition to receiving interaction information for an interaction including the operator, information may be received for detecting an interaction between an occupant, of the automotive vehicle that is not the operation, and some object.

Detecting an attention criterion may be based on time information identifying at least one of a start time, an end time, and a length of time. The time information may be identified based on an event in a plurality of events that occur irregularly in time. A length of the time period may be based on at least one of a relative time metric and an absolute time metric. For example, a length of time may be a length of time associated with monitoring the operator. Detecting that attention criterion is met may include locating and/or otherwise selecting the attention criterion based on the length of time. The attention criterion may be identified in response to detecting that the length of time meets a threshold condition.

An attention criterion may be defined and/or otherwise specified based on an attribute of an occupant of the automotive vehicle, a count of occupants in the automotive vehicle, an attribute of the automotive vehicle, an attribute of a viewport, a speed of the automotive vehicle, a view viewable to the operator, a direction of movement of at least a portion of the operator, a direction of movement of an automotive vehicle, an ambient condition in the automotive vehicle for the operator, an ambient condition for the automotive vehicle, a topographic attribute of a location including the automotive vehicle, an attribute of a route of the automotive vehicle, information from a sensor external to the automotive vehicle, and/or information from a sensor included in the automotive vehicle.

In an aspect, an attention output may be presented by attention director component 408a in FIG. 4a for a specified duration of time and/or until a specified event is detected, and/or may include a pattern of changes presented to an operator of an automotive vehicle. For example, an attention output may be presented until an operator input is detected that corresponds to the attention output and acknowledges that the operator is aware of the attention output. In response, the presentation of the attention output may be removed and/or otherwise stopped. Interaction monitor component 402a and/or another input handler (not shown) in execution environment 401a may be configured to detect a user input from an operator acknowledging an attention output.

A message identifying vehicle information and/or a message identifying interaction information may be sent from one or more of first automotive vehicle 502a in FIG. 5, second automotive vehicle 502b, and a node not included in the first automotive vehicle and not included in the second automotive vehicle illustrated by service node 504 in FIG. 5. A message identifying vehicle information and/or a message identifying interaction information may be received by one or more of first automotive vehicle 502a, second automotive vehicle 502b, and service node 504 not included in the first automotive vehicle and not included in the second automotive vehicle.

Exemplary sensing devices for receiving input for detecting an automotive vehicle include a user input device, a light sensing device, a sound sensing device, a motion sensing device, a heat sensing device, a code scanning device, a location sensing device, and a network interface hardware component.

An automotive vehicle may be detected based on one or more of a location of the automotive vehicle, an operator of the detected automotive vehicle, and an operator of another automotive vehicle.

In an aspect, determining attention information may include generating a message to be sent via a communications interface. Alternatively or additionally, attention information may be determined based on one or more of an operator, an automotive vehicle, an ambient condition, a user communications address of a communicant in a communication, a velocity of the automotive vehicle, an acceleration of the automotive vehicle, a topographic attribute of a route of the automotive vehicle, a count of occupants in the automotive vehicle, a measure of sound, and another automotive vehicle.

Interaction information may identify one or more attributes of an interaction including a direction, a measure of interaction, a type of interaction, an object included in the interaction, and an attribute of the object.

Interaction information, attention information, and/or sending attention information may be based on one or more of an attribute of an operator, a count of occupants in an automotive vehicle, a speed of an automotive vehicle, a direction of movement of an automotive vehicle, a movement of a steering mechanism of an automotive vehicle, an ambient condition, a topographic attribute of a location including an automotive vehicle, a road, information from a sensor external to an automotive vehicle, and information from a sensor included in an automotive vehicle.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD.™.), and a Blu-ray.™. disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for altering attention of an automotive vehicle operator, the method comprising:
receiving interaction information based on a first interaction that includes a first operator of a first automotive vehicle;
detecting a second automotive vehicle, wherein the second automotive vehicle is operated by a second operator;
determining, based on the interaction information, attention information for identifying an attention output; and
sending the attention information for presenting the attention output, by an output device, to alter a second interaction that includes the second operator.

2. The method of claim 1 wherein the interaction information is based on at least one of an input detected, by an input device not included in the first automotive vehicle.

3. The method of claim 2 wherein the input device includes at least one of an input component of a personal electronic device, a galvanic skin detector, a detector of a bodily substance produced by the first operator, motion detector, gaze detector, and a detector of a specified substance in the first operator.

4. The method of claim 1 wherein the interaction information is based on not detecting an input from the first operator during a specified time period.

5. The method of claim 1 wherein the interaction information identifies a measure of interaction measured according to a specified metric.

6. The method of claim 1 wherein the interaction information is received by at least one of the first automotive vehicle, the second automotive vehicle, and a node not included in the first automotive vehicle and not included in the second automotive vehicle.

7. The method of claim 1 wherein the interaction information is identified by a message received via a network.

8. The method of claim 7 wherein the message is sent from one of the first automotive vehicle, the second automotive vehicle, and a node not included in the first automotive vehicle and not included in the second automotive vehicle.

9. The method of claim 1 wherein detecting the second automotive vehicle includes sensing the second automotive vehicle via a user input device, a light sensing device, a sound sensing device, an electromagnetic signal sensing device, a motion sensing device, a heat sensing device, a code scanning device, a location sensing device, and a network interface hardware component.

10. The method of claim 9 further includes receiving second vehicle information identifying the second automotive vehicle, in response to a user input sensed via the user input device.

11. The method of claim 9 wherein detecting the second automotive vehicle includes receiving a message via a network operatively coupled to the network interface hardware component.

12. The method of claim 1 wherein the second automotive vehicle is detected by at least one of the first automotive vehicle, the second automotive vehicle, and a node not included in the first automotive vehicle and not included in the second automotive vehicle.

13. The method of claim 1 wherein the presentation information is determined based on at least one of the first operator, the second operator, the first automotive vehicle, the second automotive vehicle, an ambient condition, a user communications address of a communicant in a communication, a velocity of at least one of the first automotive vehicle and the second automotive vehicle, an acceleration of at least one of the first automotive vehicle and the second automotive vehicle, a topographic attribute of a route of at least one of the first automotive vehicle and the second automotive vehicle, a count of occupants in at least one of the first automotive vehicle and the second automotive vehicle, a measure of sound, and a third automotive vehicle.

14. The method of claim 1 wherein the presentation information identifies at least one of an object for the second operator to interact with, an object included in the first interaction, a direction in space of an object included in the first interaction, a measure of interaction, a type of sensory input detected by the first operator in the first interaction, a type of sensory input to be detected by the second operator, at least a portion of the first automotive vehicle, an attribute of the first automotive vehicle, and an attribute of the first operator.

15. The method of claim 1 wherein at least one of the interaction information, the presentation information, and sending the presentation information is based on at least one an attribute of the second operator, a count of occupants in at least one of the first automotive vehicle and the second automotive vehicle, an attribute of at least one of first automotive vehicle and the second automotive vehicle, a speed of at least one of first automotive vehicle and the second automotive vehicle, a direction of movement of at least one of first automotive vehicle and the second automotive vehicle, a movement of a steering mechanism of at least one of first automotive vehicle and the second automotive vehicle, an ambient condition, a topographic attribute of a location including the first automotive vehicle and the second automotive vehicle, a road, information from a sensor external to the first automotive vehicle and the second automotive vehicle, and information from a sensor included in at least one of first automotive vehicle and the second automotive vehicle.

16. The method of claim 1 wherein the attention output includes at least one of an audio interface element, a tactile interface element, a visual interface element, and an olfactory interface element.

17. The method of claim 1 wherein the presentation information includes time information identifying a duration for presenting the attention output to maintain the attention of the second operator.

18. The method of claim 1 wherein the presentation information is sent to change the second interaction by directing the second operator to visually interact with the first automotive vehicle.

19. A system for altering attention of an automotive vehicle operator, the system comprising:
an interaction monitor component, a vehicle detector component, and an attention control component, and an attention director component adapted for operation in an execution environment;
the interaction monitor component configured for receiving interaction information based on a first interaction that includes a first operator of a first automotive vehicle;
the vehicle detector component configured for detecting a second automotive vehicle, wherein the second automotive vehicle is operated by a second operator;
the attention control component configured for determining, based on the interaction information, attention information for identifying an attention output; and
the attention director component configured for sending the attention information for presenting the attention output, by an output device, to alter a second interaction that includes the second operator

20. A computer-readable medium embodying a computer program, executable by a machine, for altering attention of an automotive vehicle operator, the computer program comprising executable instructions for:
receiving interaction information based on a first interaction that includes a first operator of a first automotive vehicle;
detecting a second automotive vehicle, wherein the second automotive vehicle is operated by a second operator;
determining, based on the interaction information, attention information for identifying an attention output; and
sending the attention information for presenting the attention output, by an output device, to alter a second interaction that includes the second operator.
